(19) United States
(12) Patent Application Publication
(10) Pub. No.: US 2025/0335808 A1
(43) Pub. Date: Oct. 30, 2025

(54) METHOD FOR SOLVING MAXIMUM-INDEPENDENT-SET USING QUANTUM COMPUTING

(71) Applicant: Korea Advanced Institute of Science And Technology, Daejeon (KR)

(72) Inventors: Jaewook AHN, Daejeon (KR); Min Hyuk KIM, Daejeon (KR); Kangheun KIM, Daejeon (KR); Jaeyong HWANG, Daejeon (KR)

(73) Assignee: Korea Advanced Institute of Science And Technology, Daejeon (KR)

(21) Appl. No.: 18/729,360

(22) PCT Filed: Jan. 17, 2022
(86) PCT No.: PCT/KR2022/000814

§ 371 Date: Mar. 10, 2025

(51) Int. Cl. G06N 10/60

(52) U.S. Cl. CPC G06N 10/60

(57) ABSTRACT

The present invention relates to a method for solving a maximum-independent-set problem using a Rydberg quantum wire. The Rydberg quantum wire is an auxiliary wire atomic chain for synthesizing a wire graph G_{0+W} from an initial graph G₀ and mediating interactions between distant atoms. The present invention makes it possible to easily approach the MIS problem of non-planar or high-degree graphs.

### TECHNICAL FIELD

The present invention relates to a method for solving a maximum-independent-set problem, and more particularly, to a method for solving a maximum-independent-set problem using a Rydberg quantum wire.

### BACKGROUND ART

Quantum computing refers to a method for processing data by using a quantum mechanical phenomenon such as entanglement or superposition. Although researches using an extremely small number of qubits are performed and still remain at an experimental initial level, the quantum computing is considered a new technology that will change a paradigm of a future society because the quantum computing is remarkably excellent in a speed and capacity of processing data in comparison with a current computer.

One of the researches performed recently in quantum computing uses a quantum many-body system having a considerable size to solve the non-deterministic polynomial-time (NP) optimization problem. The combinatorial optimization problem is intended to derive a realizable optimized solution.

For example, the maximum-independent-set (MIS) problem involves identifying an independent vertex set having a maximum size in a graph. Although the MIS problem substantially has a classical feature, the MIS problem is difficult for a classical turing machine to solve efficiently due to a NP-complete thereof. However, when the quantum many-body system allows an intrinsic mapping for a many-body ground state problem, an evolution thereof may be designed to improve a calculation speed.

The Rydberg atom system provides a substantial Hamiltonian for the MIS problem. It is assumed that N atoms are arranged on a graph G=G(V,E) having a vertex V and an edge E which represent atoms and Rydberg blockaded atom pairs, respectively. The many-body ground state of the atoms provides a MIS solution for G, [symbol] (G). The Hamiltonian H is approximately given by Equation 1 below.

$${\hat{H}}_{G} = U {\sum }_{( j , k ) ∈ E} {\hat{n}}_{j} {\hat{n}}_{k} - \frac{h Δ}{2} {\sum }_{j ∈ V} {\hat{σ}}_{j}^{x} \qquad [ Equation 1 ]$$

Here, U represents nearest-neighbor interaction, Δ represents laser detuning, \hat{n}=(\hat{σ}^{z}+1)/2 represents Rydberg excitation, configuration n=1(n=0) represents the Rydberg (ground) state of each atom, j and k represents indices of the Rydberg atom array,

$${\hat{σ}}_{j}^{𝓏}$$

represents the Pauli z-matrix (having values of 1 or −1, 1 represents Rydberg state and −1 represents ground state). In particular, laser detuning refers to a difference between the ground-Rydberg states energy spacing and laser frequency.

It may be easily observed that the many-body ground state of Ĥ_{G} applies strong anti-ferromagnetic coupling (U> [symbol] Δ) and a positive detuning field (Δ>0) to [symbol] (G).

Thus, quantum simulation, Ĥ_{G}| [symbol] (G) [symbol] =E_{g}(G)| [symbol] (G) [symbol] , on the ground state of the Schrödinger equation finds a MIS solution.

FIG. 1 illustrates an example of a 2D Rydberg atom array simulation with 4 vertices, which is a G=3-pan graph in the information system on graph classes and their inclusion (IS-GCI) nomenclature.

FIG. 1 illustrates the Rydberg atom array in a graph manner with 4 atoms (N=4) arranged in a nearest-neighbor Rydberg blockade system, which is a G(V,E)=3-pan graph, and in which V={1,2,3,4} and E={{1,2},{2,3},{2,4},{3,4}}, and the MIS solution is [symbol] (G)={{1,3},{1,4}}.

Numbering described in FIG. 1 is suitable for using Rydberg blockade with a blockade radius rb and a ground state (|1010 [symbol] +|1001 [symbol] )/\sqrt{2} and counts atoms in a n=1 state to provide the MIS solutions, [symbol] (3-pan)={{1,3},{1,4}}.

However, the 2D Rydberg atom array for the MIS problem have two limitations.

First, as in the mathematical theorem by Kuratowski, a non-planar graph may not be simulated by 2D Rydberg atoms. Second, since a size of Rydberg atom interactions is determined by the blockade radius, a graph with high-degree vertices may not be encoded.

### PRIOR ART DOCUMENT

### Patent Document

US Patent Publication No. US2021/0279631A1 (Published on Sep. 9, 2021)

### DISCLOSURE OF THE INVENTION

### Technical Problem

The present invention provides a method for introducing a new quantum wire system in a Rydberg atom array to solve the above-described two limitations.

### Technical Solution

An embodiment of the present invention provide a method for solving a maximum-independent-set (MIS) problem by using a Rydberg quantum wire.

Also, the Rydberg quantum wire may be an auxiliary wire atomic chain that synthesizes a wire graph G_{0+W} from an initial graph G₀ and mediates an interaction between distant atoms.

Also, the method may include: a wired array construction step; a quantum simulation for the MIS problem step; and a wire information projection step.

Also, the wired array construction step may arrange qubit atoms to express the initial graph G₀ and couple the auxiliary wires.

Also, the auxiliary wire may connect atoms, which are not adjacent to each other, included in the initial graph.

Also, the quantum simulation step may obtain a ground state of Hamiltonian based on the Schrödinger equation.

Also, a quantum state in a Hilbert space of the wire graph G_{0+W} generated in the wired array construction step may be projected onto the Hilbert space of a target graph G_{T}.

Also, the MIS problem may be solved based on a MIS solution of the target graph G_{T}.

Also, the wired array construction step may perform the initial graph G₀ with respect to a nonplanar or high-degree graph.

### Advantageous Effects

According to the present invention, the MIS problem of the non-planar or high-degree graph may be easily approached.

### BRIEF DESCRIPTION OF THE DRAWINGS

FIG. 1 is a view illustrating an example of a two-dimensional Rydberg atom array simulation.

FIG. 2 is a view illustrating a wired array construction step according to the present invention.

FIGS. 3 and 4 are views illustrating present various experimental examples of the Rydberg quantum wire.

FIG. 5 is a view illustrating various experimental examples of a Rydberg quantum wire for a Kuratowski subgraph.

FIG. 6 is a view illustrating additional application examples of the Rydberg quantum wire according to the present invention.

FIG. 7 is a table showing a 3D atom position in an experiment for the present invention.

FIG. 8 is a table showing details of the experiment for the present invention.

FIG. 9 is a table showing an experimental process and a time budget for the present invention.

FIG. 10 is a table showing the experimental errors in the experiment for the present invention.

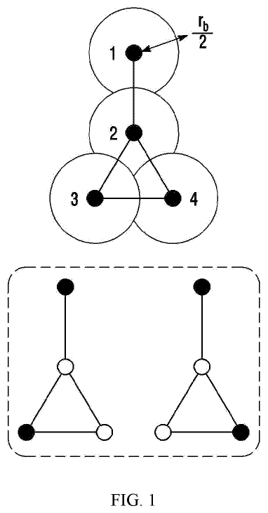

### MODE FOR CARRYING OUT THE INVENTION

Hereinafter, embodiments disclosed in this specification is described with reference to the accompanying drawings, and the same or corresponding components are given with the same drawing number regardless of reference number, and duplicated descriptions thereof will be omitted. Moreover, detailed descriptions related to well-known functions or configurations will be ruled out in order not to unnecessarily obscure subject matters of the present invention. However, this does not limit the present invention within specific embodiments and it should be understood that the present invention covers all the modifications, equivalents, and replacements within the idea and technical scope of the present invention.

A quantum wire is a chain of auxiliary wire atoms proposed to mediate a strong interaction between distant atoms in a method capable of synthesizing a complex target graph G_{T} in a simple initial graph G₀. Although the above-described quantum wire may be basically realized by using a local addressing field, the quantum wire is difficult to be realized from a current Rydberg atom experiment.

The present invention proposes an alternative quantum wire method that is the Rydberg quantum wire that does not requires local addressing. According to the present invention that will be described below, a maximum-independent-set (MIS) problem of a non-planar or high-degree graph may be easily approached. The local addressing represents an experimental process of applying a laser beam having a small size to only specific atoms in an array, unlike global addressing that applies a laser beam having a big size enough to cover an entire given array. In addition, quantum annealing that will be described below represents a process of adiabatically changing an external system of atoms, such as a laser, to ultimately find a ground state of a many-body system.

The Rydberg quantum wire system includes three steps of a wired array construction step, a quantum simulation for a MIS problem step, and a wire information projection step.

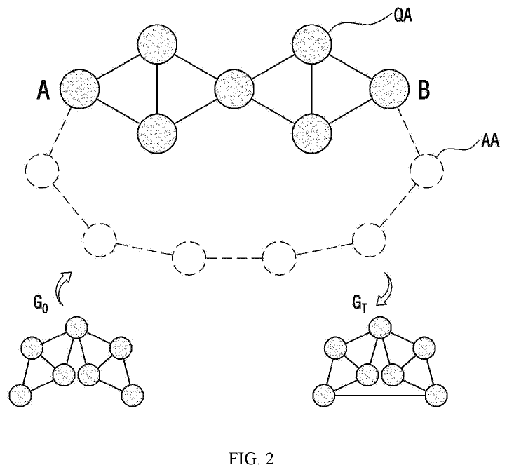

FIG. 2 illustrates the wired array construction step. Specifically, FIG. 2 illustrates a concept of the Rydberg quantum wire, in which qubit atoms QA are arranged to represent an initial graph G₀=X₁₀₁. When a chain of auxiliary atoms AA does not create a new edge between non-adjacent atoms (vertices A and B of G₀), a combined graph G_{0+W} (qubit and wire atoms) shares the same MIS solution to construct a target graph G_{T}, i.e., the Moser spindle graph.

In other words, as illustrated in FIG. 2, in the wired array construction step, a quantum wire (formed by AAs) of an even number (M=6) of wire atoms is added to the initial graph G₀=X₁₀₁ (formed by QAs) to couple A qubit atoms and B qubit atoms. When the quantum wire is processed as the edge, the combined graph G_{0+W} is the same as the target graph G_{T} that is the Moser spindle graph.

In the quantum simulation step, a ground state of Hamiltonian is obtained by solving the Schrödinger equation in Equation 2, e.g., experimental quantum annealing.

$${\hat{H}}_{{G}_{0 + w}} \vert 𝕄 ( {G}_{0 + w} ) 〉 = {E}_{g} ( {G}_{0 + w} ) \vert 𝕄 ( {G}_{0 + w} ) 〉 \qquad [ Equation 2 ]$$

A size of the Hilbert space of G_{T} is different by a factor of 2^{M} from that of G_{0+W}. Here, M represents the number of added atoms for the quantum wire. Thus, as a final step, an additional operation of a quantum state of G_{0+w} is performed. The MIS solution of the target graph [symbol] (G_{T}), may be given by [Equation 3] below.

$$\vert 𝕄 ( {G}_{t} ) 〉 = {ℙ}_{4} {ℙ}_{H} [ \vert 𝕄 ( {G}_{0 + w} ) 〉 ] \qquad [ Equation 3 ]$$

A first calculation ( [symbol] _{H}) projects the quantum state in the enlarged Hilbert space of G_{0+w} onto the Hilbert space of the target graph G_{T}. This may be easily performed by measuring qubit information of G_{T}. Thereafter, the above-described projection is designated by introducing a bar notation such as [symbol] (G)→ [symbol] (G).

A second calculation ( [symbol] _{F}) removes a configuration [symbol] (G_{0+w}) that violates the Rydberg blockade condition between qubits at a boundary, among some elements of [symbol] (G_{0+w}). Then, the MIS solution of G_{T} is obtained as [Equation 4].

$$𝕄 ( {G}_{T} ) = \overline{𝕄} ( {G}_{0 + w} ) - \overline{𝔽} ( {G}_{0 + w} ) \qquad [ Equation 4 ]$$

The Rydberg quantum wire system proposed in the present invention uses quantum entanglement of two quantum many-body systems. That is, qubits of the two systems are entangled to access the MIS solution of the target graph.

The quantum simulation for the MIS problem step is performed through quantum annealing of a 3D atom array. In an experiment, neutral ⁸⁷Rb atoms are arranged such that all nearest-neighbor atom pairs, which describe edges of graphs, are maintained at an interatomic distance d less than the Rydberg blockade radius. That is, d<r_{b}=(C₆/hΩ)^{1/6}=9.8 μm. Also, all other atom pairs that are not connected by edges are arranged at a farther distance.

A ground state |5S_{1/2}, F=2, m_{F}=2 [symbol] =|n=0 [symbol] and a Rydberg state |71S_{1/2}, m_{J}=1/2 [symbol] =|n=1 [symbol] of each atom are used for a qubit two state system.

An effective Hamiltonian for the atom array is given by [Equation 5] below.

$$\hat{H} ( t ) = U {\sum }_{( j , k ) ∈ E} {\hat{n}}_{j} {\hat{n}}_{k} - \frac{h Δ}{2} {\sum }_{j ∈ V} ( δ ( t ) {\hat{σ}}_{j}^{𝓏} - Ω ( t ) {\hat{σ}}_{j}^{x} ) \qquad [ Equation 5 ]$$

Here, the Pauli matrices having two states in j-th and k-th atoms are expressed as

$${\hat{n}}_{j , k} = ( {\hat{σ}}_{j , k}^{𝓏} + 1 ) / 2.$$

Each term at a right side represents a van der Waals interaction at the fixed distance d, a time-dependent detuning, and a time-dependent Rabi frequency.

At the beginning, the atoms are prepared in the paramagnetic down spins at t=0, |00 . . . 0>, with δ(0)=−Δᵢ<0 and Ω(0)=0. In order to find the MIS solution of G, the atoms are driven quasi-adiabatically to a many-body ground state of Ĥ_{G} by turning the Rabi frequency on/off while the detuning gradually increases until δ(t=t_{f})=Δ_{f}<U.

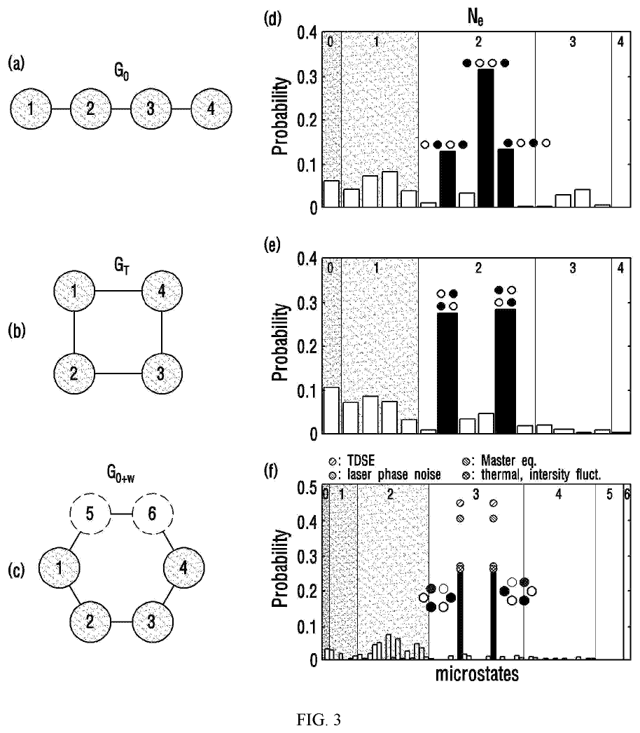

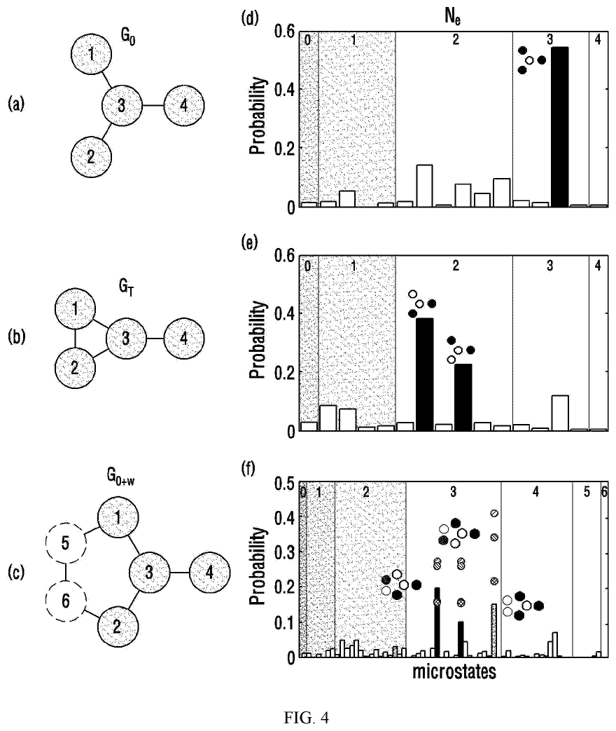

FIGS. 3 and 4 illustrate an experiment of the Rydberg quantum wire. The present invention considers experimental tests of the Rydberg quantum wire in a case with frustration and a case without frustration, i.e., when [symbol] (G_{0+w})=∅ or ≠∅ in the above Equation 4.

FIG. 3 illustrates the case without frustration. Specifically, in case of a graph without the frustration, an initial graph G₀=P₄ illustrated in (a) of FIG. 3 and a target graph G_{T}=C₄ illustrated in (b) of FIG. 3 are considered.

As illustrated in (c) of FIG. 3, a wire graph G_{0+W}=C₆ is constructed by adding Rydberg quantum wires 5 and 6 with M=2.

Thereafter, as illustrated in (d), (e), and (f) of FIG. 3, the quantum simulation observes a high-population state, in which the MIS solution is summarized as [symbol] (G₀)={{2,4},{1,4},{1,3}}, [symbol] (G_{0-w})={{2,4},{1,3}} and [symbol] (G_{T})={{2,4},{1,3}}.

[symbol] (G_{0+w})=∅ and [symbol] (G_{T})= [symbol] (G_{0+w}) that satisfy the MIS solution of Equation 4 may be easily identified.

A population difference between the MIS solutions of G₀ in (d) of FIG. 3 is based on the fact that quantum annealing causes a coherent superposition of the MIS solution, | [symbol] (G₀) [symbol] =(|0101 [symbol] +1010 [symbol] )/\sqrt{2}+0110 [symbol] /2.

FIG. 4 illustrates the case with frustration. In case of a graph with frustration, i.e., when [symbol] (G_{0+w})≠∅, an initial graph G₀=S₄ and a target graph G_{T}=3-pan as illustrated in (a) and (b) of FIG. 4 are considered. As illustrated in (c) of FIG. 4, a wire graph constructed by the Rydberg quantum wires is G_{0+W}=5-pan.

Quantum simulations of G₀, G_{T}, and G_{0+W} are illustrated in (d), (e), and (f) of FIG. 4, respectively, in which the high-population states are given as [symbol] (G₀)={{1,2,4}}, [symbol] (G_{T})={{1,4},{2,4}} and [symbol] (G_{0+w})={{1,4},{2,4},{1,2,4}}. Also, the MIS solution [symbol] (G_{T})= [symbol] (G_{0+w})− [symbol] (G_{0+w}) is also confirmed. Here, [symbol] (G_{0+w})={{1,2,4}} is the frustration configuration.

Thereafter, a nonplanar graph focusing on K₅ and K_{3.3} that are Kuratowski subgraphs are considered. A main research of Kuratowski shows that a graph G is nonplanar only when one of two Kuratowski subgraphs is contained in the graph G.

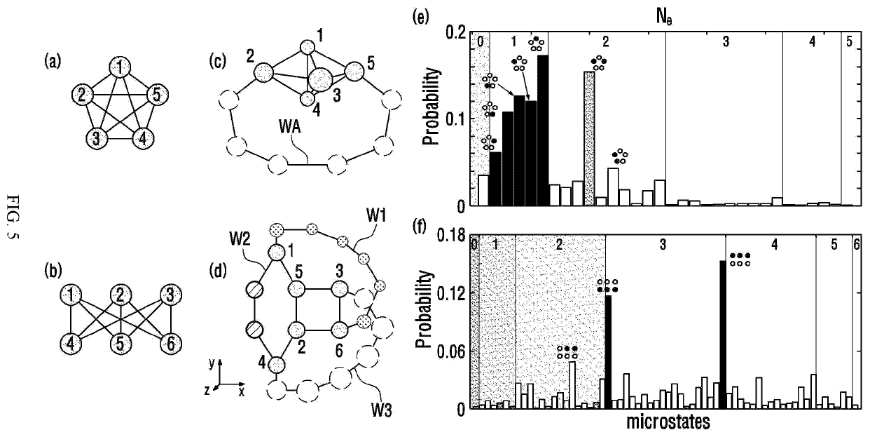

K₅ in (a) of FIG. 5 is a complete graph in which each vertex is connected to all other vertices by an edge, and K_{3,3} in (b) of FIG. 5 is a bipartite graph in which three vertices at one side are completely connected to vertices at the other side. Both the two graphs require the quantum wires in addition to the 3D atom array.

As illustrated in (c) and (d) of FIG. 5, wire graphs

$${G}_{0 + w} = {K}_{5}^{exp} and {K}_{3.3}^{exp}$$

are constructed, and each of the target graphs G_{T}=K₅ and K_{3,3} is simulated.

As illustrated in (c) of FIG. 5, the initial graph is G₀=K₅−e of five qubit atoms 1, 2, 3, 4, and 5 in a tetrahedral configuration, in which two qubit atoms 2 and 5 are connected to six wire atoms WA.

Quantum annealing is performed by using the constructed

$${K}_{5}^{exp} ,$$

and a result thereof is illustrated in (e) of FIG. 5. Six peaks corresponding to five singly-excited solutions (black bars), {1}, {2}, . . . , {5}, and a doubly-excited solution {2, 5} (gray bar) are observed. The final solution {2, 5} is frustrated, and the MIS solution of K₅ is obtained by the above [Equation 4], [symbol] (K₅)={{1},{2}, . . . {5}}. A non-uniform probability of the singly-excited state is caused by a difference between higher-order interactions for other qubit atoms and the quantum wire, which are ignored in Equation 4, and this is mainly caused by asymmetry of physical realization (e.g., atom 3 is maintained closer to atom 5 to avoid an interference of holographic optical potentials).

The initial graph representing

$${K}_{3.3}^{exp}$$

in (d) of FIG. 5 is graph A 1, 2, 3, 4, 5, and 6, and three quantum wires W1, W2, and W3 are used to connect pairs (1, 6), (1, 4), and (3, 4) of the initial graph, respectively.

As illustrated in (f) of FIG. 5, the quantum annealing of the constructed

$${K}_{3.3}^{exp}$$

produces two peaks (black bars) corresponding to two MIS solutions {1, 2, 3} and {4, 5, 6} of

$${K}_{3.3}^{exp}$$

Both two solutions are not frustrated, and the Rydberg quantum wire algorithm of [Equation 4] experimentally finds the MIS solution of K_{3,3} as [symbol] (K_{3,3})={{1,2,3},{4,5,6}}.

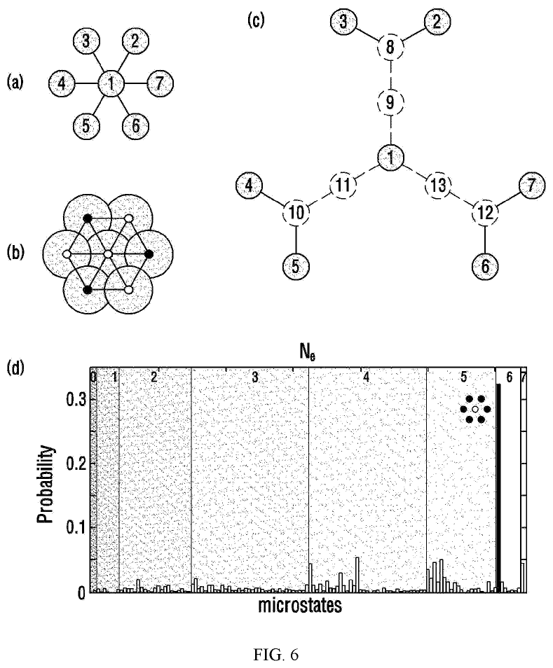

High-degree vertex graphs illustrated in FIG. 6 may be considered as an additional application of the Rydberg quantum wire. Realization of the high-degree vertices using the Rydberg atom array is important in quantum simulation.

For example, as illustrated in (a) of FIG. 6, a star graph S₆ having a 6-degree vertex at a center thereof is impossible to perform a simulation in a 2D array without the quantum wire method. This is because a wheel graph W7 is changed as illustrated in (b) of FIG. 6 when atoms are realized in 2D.

The present invention uses the Rydberg quantum wire, which is also known as vertex splitting in graph theory, to reduce a degree of a high-degree vertex. As illustrated in (c) of FIG. 6, a 13-vertex extended tree-like graph,

$${S}_{6}^{exp}$$

is constructed from the initial graph, 7K₁ having seven isolated vertices.

Three quantum wires are used to add three 3-degree vertices to split a 6-degree central vertex.

A result of the quantum annealing of the constructed

$${S}_{6}^{exp}$$

is illustrated in (d) of FIG. 6. It was confirmed that a single peak corresponds to the MIS solution of

$${S}_{6}^{exp} .$$

### That is,

$$\overline{𝕄} ( {S}_{6}^{exp} ) = \{ \{ 2 , 3 , ⋯ , 7 \} \}$$

this is the MIS solution {1,2,3}, which is not frustrated ( [symbol] (G_{0+w})=∅). Also, it was observed that the Rydberg quantum wire method may successfully construct the high-degree graphs.

The present invention proposes and experimentally verifies the Rydberg quantum wire method that uses a Rydberg many-body interaction along a neutral atom wire to program complex connections of the non-planar and high-degree graphs required for general MIS problem.

K₅, K_{3,3}, and the 6-degree graph S₆ are constructed by using the 3D array of the qubits and quantum wire atoms, and the many-body ground state is observed by using the quasi-adiabatic quantum annealing process. The observed ground-states of the quantum-wired systems show excellent match with, or algorithmically retrieved, the MIS solutions of the target graphs.

### Quantum Mechanics of MIS Problem Using Rydberg Quantum Wire

The present invention is intended to find the MIS solution of the target graph G_{T}, and the target graph G_{T} may be obtained by finding the ground state of the Schrödinger equation for the target Hamiltonian as in [Equation 6] below.

$${\hat{H}}_{T} \vert ?? ( {G}_{T} ) 〉 = {E}_{g} ( {G}_{T} ) \vert 𝕄 ( {G}_{T} ) 〉 \qquad [ Equation 6 ]$$

However, the construction of G_{T} basically has a limitation by the non-planar graphs and the high-degree vertices.

In order to overcome the limitation, the present invention observes the wire graph G_{0+W} and obtains the MIS solution of G_{T}. A basic fact is [symbol] (G_{T})⊂ [symbol] (G_{0+w}), and this may be easily expressed by replacing the edges of G_{T} through the quantum wires. The MIS solution of G_{0+W} may be obtained by solving the Schrödinger equation in Equation 7 below:

$${\hat{H}}_{0 + w} \vert 𝕄 ( {G}_{0 + w} ) 〉 = {E}_{g} ( {G}_{0 + w} ) \vert 𝕄 ( {G}_{0 + w} ) 〉 \qquad [ Equation 7 ]$$

On the other hand, the ground state is given by Equation 8 below.

$$\vert 𝕄 ( {G}_{0 + w} ) 〉 = {\sum }_{j} {C}_{j} \vert {ψ}_{j} 〉 = {\sum }_{j} {C}_{j} \vert {ψ}_{j} 〉 ⊗ \vert {ψ}_{j} 〉 \qquad [ Equation 8 ]$$

Here, a qubit state |ψⱼ [symbol] (entangled state |Ψⱼ [symbol] ) is disposed in the Hilbert space having a size of 2^{N}(2^{N+M}). Here, N and M represent the number of qubits in the target graph and the wire, respectively. The MIS solution of the wire graph is given by [Equation 9] below:

$$𝕄 ( {G}_{0 + w} ) = \{ ( {ψ}_{1} , {ϕ}_{1} ) , ( {ψ}_{2} , {ϕ}_{2} ) \} \qquad [ Equation 9 ]$$

Here, a projection operator [symbol] _{H} is introduced, which is defined as in [Equation 10] below.

$${ℙ}_{H} \vert {Ψ}_{j} 〉 = \vert {ψ}_{j} 〉 \qquad [ Equation 10 ]$$

Although a Fock space having the different number of qubits is mathematically required, the above notation is safe to be used for the MIS problem. A projected state is given by [Equation 11] below.

$${ℙ}_{H} \vert 𝕄 ( {G}_{0 + w} ) 〉 = {\sum }_{j} {C}_{j} \vert {ψ}_{j} 〉 \qquad [ Equation 11 ]$$

Also, a solution set corresponding thereto is given by [Equation 12] below.

$$\overline{𝕄} ( {G}_{0 + w} ) = \{ {ψ}_{1} , {ψ}_{2} , ⋯ , {\hat{ψ}}_{1} , {\hat{ψ}}_{2} , ⋯ \} \qquad [ Equation 12 ]$$

A bar notation is introduced in order to specify the projection. Some elements of [symbol] (G_{0+w}) are not a MIS problem solutions to G_{T}. A frustration function defined by ƒ(n_{A},n_{B})=n_{A}n_{B} may be introduced. Here, n=1 (n=0) denotes the Rydberg (ground) state of each atom, and A and B denote an index of the Rydberg atom array.

This is an eigen value of the number operator at a boundary at which wires are connected. For some elements of [symbol] (G_{0+w}), the Rydberg blockade condition, ƒ(n_{A},n_{B})=1, may be tested. Also, a set, [symbol] (G_{0+w})={\tilde{ψ}₁,\tilde{ψ}₂, . . . }, having a condition is obtained. Thereafter, a second projection operator may be introduced.

The second operator [symbol] _{F}= [symbol] −Σₐ|\tilde{ψ}ₐ [symbol] \tilde{ψ}ₐ| is introduced. Also, a final state is given by [Equation 13] below.

$$\vert 𝕄 ( {G}_{T} ) 〉 = {ℙ}_{F} {ℙ}_{H} [ \vert 𝕄 ( {G}_{0 + w} ) 〉 ] \qquad [ Equation 13 ]$$

Also, the solution set is given by [Equation 14] below.

$$𝕄 ( {G}_{T} ) = \overline{𝕄} ( {G}_{0 + w} ) - \overline{𝔽} ( {G}_{0 + w} ) = \{ {ψ}_{1} {ψ}_{2} , ⋯ \} \qquad [ Equation 14 ]$$

### Rydberg-Atom Quantum Simulator

An experiment of Rydberg quantum wires is performed by a 3D Rydberg-atom quantum simulator including a magneto-optical trap (MOT) for ⁸⁷Rb atoms, an optical system for holographic optical tweezers, a laser system for Rydberg-atom excitation, and a single atom detection system.

Atoms are cooled to 30 μK in the MOT by Doppler and polarization gradient cooling and optically jumped to a ground hyperfine state of |0 [symbol] =|5S_{1/2}, F=2, m_{F}=2 [symbol] .

The MOT is turned off, and then the optical tweezers (far-off-resonance optical dipole traps) are turned on to capture single atoms. Up to 250 optical tweezers may be formed in a space of 5 μm to 10 μm by using an 820 nm laser (Ti: sapphire CW laser from Avesta), a spatial light modulator (SLM, ODPDM512 from Meadowlark Optics), and a microscope objective lens (Mitutoyo G Plan Apo 50X). Each optical tweezer has a trap depth of 1 mK, a diameter of 2 μm, and a lifetime of 40(10) seconds.

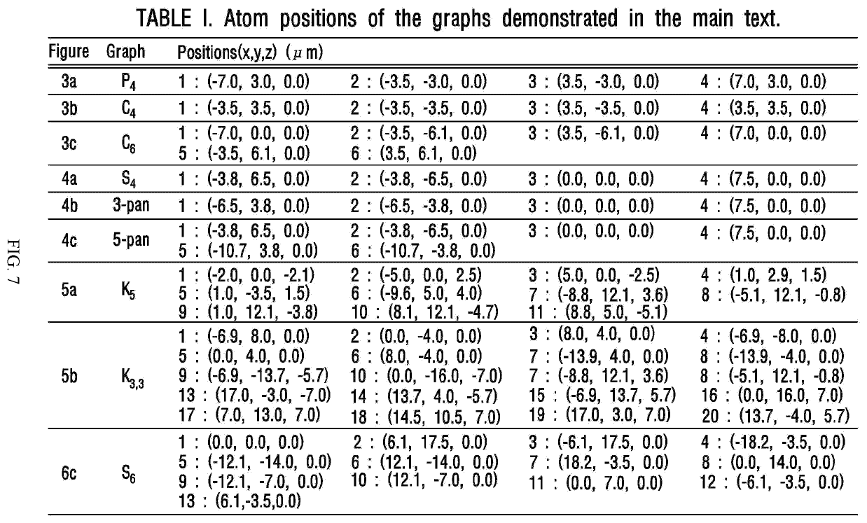

N optical tweezers are used at target atom positions, and other N optical tweezers are used as a reservoir around targets to create a defect-free array of N atoms. An atomic occupancy of the optical tweezers is determined by a fluorescence image |5S_{1/2}, F=2 [symbol] −|5P_{3/2}, F=3 [symbol] with an electron-multiplied CCD camera and an electrically tunable lens ETL (EL-16-40-TC from Optotune). Lateral and axial resolutions are 0.3 μm and 0.5 μm, respectively. After the occupancy is confirmed, the captured atoms are rearranged by the optical tweezers adjusted according to a path set obtained by the Hungarian algorithm. The 3D Gerchberg-Saxton (GS) algorithm is used to program dynamic holograms that performs a real-time calculation with a GPU (NVIDIA, Titan-X Pascal). The 3D GS algorithm is used to quickly converge a weighted feedback of a target site intensity by using a phase pattern calculated from a previous iteration as an initial phase pattern for all iterations. For example, 35 iterations take about 700 ms and are sufficient to move the traps by about 20 μm with over 90% occupancy probability at each site. The 3D atomic positions of all experimental graphs are listed in the table in FIG. 7.

Atoms undergo two-photon excitations from a ground state |0 [symbol] =|5S_{1/2}, F=2, m_{F}=2 [symbol] through an intermediate state |m [symbol] =5P_{3/2}, F=3, m_{F}=3 [symbol] to the Rydberg state |1 [symbol] =|71S_{1/2}, mⱼ=1/2 [symbol] . In the experiment, 780 nm (custom-manufactured extra cavity diode laser) and 480 nm (Toptica's TA-SHG Pro) lasers are used, which are |0 [symbol] →|m [symbol] and |m [symbol] →|1 [symbol] , respectively. Both lasers are frequency-stabilized to an ultra-low expansion cavity (Stable laser systems, finesse 15000) using the Pound-Drever-Hall method. An effective Rabi frequency for transition of the two photons is Ω=Ω₇₈₀|Ω₄₈₀/2Δₘ=2π×0.88(1), in which Ω₇₈₀=2π×50 MHz and Ω₄₈₀=2π×20 MHz are the Rabi frequencies, and Δₘ=2π×570 MHz is the intermediate detuning. The laser power of the 780 nm (480 nm) beam is 50 μW (550 mW), and a diameter of the 1/e² beam is 180 μm (100 μm). This is sufficient to include an atom array that uses almost uniform Rabi frequencies with less than 10% deviation. A typical decay time of a single atom Rabi oscillations is 7(2) μs.

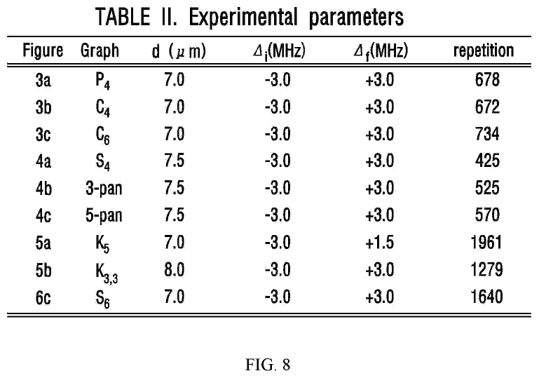

In case of quantum annealing, control parameters δ(t) and Ω(t) of the Hamiltonian Ĥ(t) in [Equation 5] are adjusted from a paramagnetic phase condition of δ(t=0)=Δᵢ<0 and Ω(t=0)=0 to a MIS phase condition of δ(t=t_{f})=Δ_{f}<U and Ω(t=t_{f})=0. During t_{f}=4 μs, calculations in three regions are used. In a first region from t:0 to t_{f}/10, δ(t) is fixed at Δi, and Ω(t) increases linearly from 0 to Ω₀, so that the initial state is evolved to the ground state of the quantum Ising Hamiltonian. Thereafter, in a second region from t/10 to 9 t_{f}/10, δ(t) increases linearly from Δi<0 to Δf>0, while Ω(t) remains constant at Ω₀. Finally, in a third region from t:9 t_{f}/10 to t_{f}, Ω(t) gradually decreases to 0, and δ(t) is fixed at Δf. The table in FIG. 8 shows an interatomic distance d, an initial detuning Δi, a final detuning Δf, and the number of measurement repetitions for each experiment.

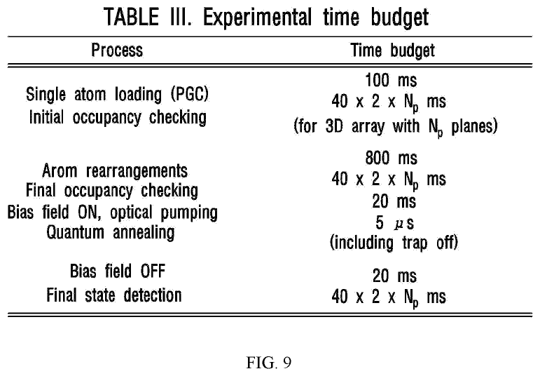

The experimental time budget is shown in FIG. 9. After the process, a evolved atomic state is detected by fluorescence of ground-state atoms during a 40 ms cycle transition to |5P_{3/2}, F=3 [symbol] , and the process is repeated until a probability distribution is obtained. In the experiment, state-preparation-and-detection (SPAM) errors are P(|0 [symbol] ∥1 [symbol] )=0.18 and P(1∥0 [symbol] )=0.03. A measured microstate S by using the above-described parameters may be reconstructed into an error-corrected microstate S′ by S′=(M⁻¹)^{⊗N}S (N: number of atoms). Here, M is a SPAM error matrix as shown in [Equation 15].

$$M = [ \begin{matrix}1 - P ( \vert 0 〉 \vert \vert 1 〉 ) & P ( \vert 1 〉 \vert \vert 0 〉 ) \\ P ( \vert 0 〉 \vert \vert 1 〉 ) & 1 - P ( \vert 1 〉 \vert \vert 0 〉 )\end{matrix} ] \qquad [ Equation 15 ]$$

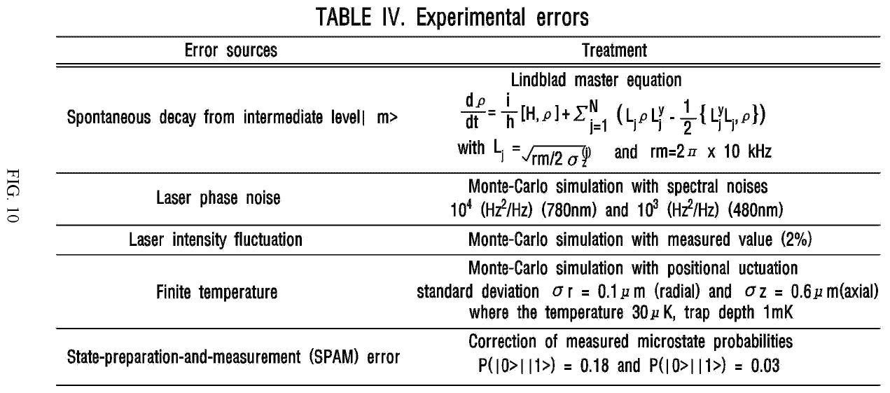

FIG. 10 is a list of experimental errors. Dominant errors occur from a spontaneous decay rate of the intermediate state and laser phase noise. Although the spontaneous decay of the Rydberg state (10⁴ greater than the lifetime of |m [symbol] ) may be ignored, a scattering rate for |m [symbol] is γₘ=2π×10 KHz. A phase noise of the Rydberg excitation lasers is measured by a frequency noise spectrum of the error signal while both lasers are stabilized. A total spectral density of the frequency noise is measured around the Fourier frequency near the Rabi frequency Ω₀, being 10⁴ (Hz²/Hz) for 780 nm and 10³ (Hz²/Hz) for 480 nm. Numerical simulations using the Lindblad master equation, considering these effects, are described as “Master” in (f) of FIG. 3 and (f) of FIG. 4. Additional experimental errors occur from a finite temperature of the atoms and intensity fluctuations of the Rydberg excitation lasers. The temperature of the atoms in the tweezers causes uncertainty in exact positions of the atoms. For a temperature of 30 μK and a trap depth of 1 mK, a standard deviation of the position is calculated as σᵣ=0.1 μm in the radial direction and σ_{z}=0.6 μm in the axial direction (tweezer propagation direction). The intensity fluctuation of the lasers is about 2%. Monte Carlo numerical simulations, using these effects, are performed and shown as “thermal, intensity fluc.” in (f) of FIG. 3 and (f) of FIG. 4.

The above-described method for solving the maximum independent set using quantum computing may be performed by a quantum computer, various devices capable of realizing quantum computing, or a quantum simulator.

Features, structures, and effects described in the above embodiments are incorporated into at least one embodiment of the present invention, but are not limited to only one embodiment. Moreover, features, structures, and effects exemplified in one embodiment may easily be combined and modified for another embodiment by those skilled in the art. Therefore, these combinations and modifications should be construed as falling within the scope of the present invention. Moreover, features, structures, and effects exemplified in one embodiment may easily be combined and modified for another embodiment by those skilled in the art. Therefore, these combinations and modifications should be construed as falling within the scope of the present invention.

1. A method for solving a maximum-independent-set (MIS) problem by using a Rydberg quantum wire.

2. The method of claim 1, wherein the Rydberg quantum wire is an auxiliary wire atomic chain that synthesizes a wire graph G_{0+W} from an initial graph G₀ and mediates an interaction between distant atoms.

3. The method of claim 2, comprising:
a wired array construction step;
a quantum simulation for the MIS problem step; and
a wire information projection step.

4. The method of claim 3, wherein the wired array construction step arranges qubit atoms to express the initial graph G₀ and couples the auxiliary wires.

5. The method of claim 4, wherein the auxiliary wire connects atoms, which are not adjacent to each other, included in the initial graph.

6. The method of claim 3, wherein the quantum simulation step obtains a ground state of Hamiltonian based on the Schrödinger equation.

7. The method of claim 3, wherein a quantum state in a Hilbert space of the wire graph G_{0+W} generated in the wired array construction step is projected onto the Hilbert space of a target graph G_{T}.

8. The method of claim 7, wherein the MIS problem is solved based on a MIS solution of the target graph G_{T}.

9. The method of claim 1, wherein the wired array construction step performs the initial graph G₀ with respect to a nonplanar or high-degree graph.
